(19) United States
(12) Patent Application Publication
(10) Pub. No.: US 2015/0309782 A1
(43) Pub. Date: Oct. 29, 2015

(54) APPLICATION PROGRAM DOWNLOAD AND UPDATE METHOD FOR VEHICLE DEVICE

(71) Applicant: E-LEAD ELECTRONIC CO., LTD., CHANGHUA (TW)

(72) Inventor: Stephen CHEN, CHANGHUA (TW)

(73) Assignee: E-LEAD ELECTRONIC CO., LTD., CHANGUHA (TW)

(21) Appl. No.: 14/264,016

(22) Filed: Apr. 28, 2014

(51) Int. Cl. G06F 9/445; H04L 29/08

(52) U.S. Cl. CPC G06F 8/65; H04L 67/12; G06F 8/61; H04L 67/10

(57) ABSTRACT

The present invention relates to an application program download and update method for vehicle device. The method includes installing a proprietary micro-management application program in a mobile device, and when a network server has an update file for a vehicle device, the network server pushes an update note to the mobile device. The user is then able to download the update file to the mobile device and, through a connection between the mobile device and the vehicle device, transmit the update file from the mobile device to the vehicle device to run a program update of the vehicle device. The vehicle owner is thus able to download the update program to update the vehicle device himself, thereby eliminating the formality and inconvenience of having to return the vehicle for servicing.

### BACKGROUND OF THE INVENTION

(a) Field of the Invention

The present invention relates to an application download and update method for vehicle device, and more particularly to a download and update method that allows a vehicle owner to update programs on a vehicle device by himself, thereby eliminating the formality and inconvenience of having to return the vehicle for servicing.

(b) Description of the Prior Art

If a defect is discovered in a general vehicle mount computer (also known as a vehicle device truck computer) installed on a vehicle when in use, or the vehicle mount computer requires upgrading, and the owner wishes to update the vehicle mount computer already installed on the vehicle, normally, a vehicle manufacturer will send a memory card (SD (Secure Digital) card, USB (Universal Serial Bus) flash drive, or CD-ROM) with the program update included on it to a vehicle service depot or a vehicle distributor. Then the vehicle service depot or distributor notifies the vehicle owners one by one to return their vehicle to the depot to carry out the update.

Another method involves the vehicle manufacturer sending the program update to a diagnostic device in the service depot through the Internet network. The vehicle in the service depot is then connected to the diagnostic device to carry out the program update of the vehicle mount computer. However, both the aforementioned methods require the vehicle to be called back to the service depot, and only then can the update be performed. Moreover, the service depot personnel also require training to perform the program update and ensuring they pay attention to related details. Hence, there is an enormous waste of time and cost, and such methods are also extremely inconvenient for the vehicle owner.

Regarding mobile devices using online operating techniques for program updating, related technologies have been previously disclosed in patents including Taiwan publication No. 201315630, Taiwan publication No. 201323267, Taiwan patent No. 1270010, Taiwan patent No. M449960, Taiwan publication No. 201117046, Taiwan patent No. 1306357, Taiwan patent No. M434698, Taiwan patent No. M437575, and Taiwan patent No. M461081. Wherein the technology used by the mobile device to carry out an online update is primarily through an Internet module installed in the mobile device. The majority of the update steps disclosed in the prior art must be carried out in an online mode, only then can program updating operations be carried out on a vehicle device or a portable electronic device. In an off line mode, the mobile device is not able to transmit the downloaded update file to the vehicle device or the portable electronic device to carry out program updating operations. Hence, there are still a certain amount of restrictions and inconvenience for the owner or user when carrying out updating operations on a vehicle device or portable electronic device.

### SUMMARY OF THE INVENTION

In light of the shortcomings of the prior art, the inventor of the present invention attentively researched various methods to resolve such shortcomings, which, following continuous research and improvements, culminated in the design of an application program download and update method for vehicle device as described hereinafter. The objective of the present invention lies in providing download and update methods that allow an owner to update programs on a vehicle device by himself, thereby eliminating the formalities and inconvenience of having to return the vehicle to a service depot for servicing.

In order to achieve the aforementioned objective, a first embodiment of an application program download and update method for vehicle device of the present invention comprises the following steps:

a, Installing a proprietary micro-management application program in a mobile device, wherein the proprietary micro-management application program is used to manage program update of a vehicle device; and connecting the mobile device to the vehicle device, whereupon the vehicle device transmits back the program version information of the vehicle device to a network server.

b, Performing a comparison of the program version of the vehicle device with the version on the network server. If the program version of the vehicle device is an older version, then the network server pushes an update note to the mobile device paired with the vehicle device.

c, Displaying the update note on the screen of the mobile device, and opening the proprietary micro-management application program of the mobile device; pressing a Yes key to agree to begin the download, and then downloading and storing the update file in the mobile device.

d, Connecting the mobile device to the vehicle device, whereupon the network server notifies the vehicle device to run the update program. The vehicle device then displays information on the updated version and advises opening the proprietary micro-management application program window on the mobile device.

e, Pressing the Yes key to agree to run the update program, whereupon the mobile device transmits the update file to the vehicle device, and the vehicle device retrieves the update program from the update file and updates the vehicle device.

The aforementioned application program download and update method for vehicle device further comprises the following step:

f, Transmitting back an update completion note by the vehicle device after updating thereof, whereupon the mobile device transmits the update completion note to the network server, and the network server makes a record of the updated version of the vehicle device.

The aforementioned vehicle device is paired with a plurality of mobile devices.

A second embodiment of the aforementioned application program download and update method for vehicle device of the present invention comprises the following steps:

a, Installing a proprietary micro-management application program in a mobile device, wherein the proprietary micro-management application program is used to manage program update of a vehicle device; and connecting the mobile device to the vehicle device, whereupon the proprietary micro-management application program makes a record of the program version of the vehicle device, and the mobile device transmits back the program version information of the vehicle device to a network server;

b, Performing a comparison of the program version of the vehicle device with the version on the network server. If the program version of the vehicle device is an older version, then the network server pushes an update note to the mobile device paired with the vehicle device.

c, Displaying the update note on the screen of the mobile device, and then opening the proprietary micro-management application program of the mobile device. Pressing the Yes key to agree to run the program and downloading and storing the update file in the mobile device;

d, Connecting the mobile device to the vehicle device, whereupon the network server notifies the vehicle device to run the update program. The vehicle device then displays information on the updated version and advises opening the proprietary micro-management application program window on the mobile device.

e, Pressing the Yes key to agree to run the update program, whereupon the mobile device transmits the update file to the vehicle device, and the vehicle device retrieves the update program from the update file and updates the vehicle device.

The aforementioned application program download and update method for vehicle device further comprises the following step:

f, Transmitting back an update completion note by the vehicle device after updating thereof, whereupon the mobile device then transmits the update completion note to the network server, and the network server makes a record of the updated version of the vehicle device.

The aforementioned vehicle device. is paired with a plurality of mobile devices.

A third embodiment of the application program download and update method for vehicle device of the present invention comprises the following steps:

a, Installing a proprietary micro-management application program in a mobile device, wherein the proprietary micro-management application program is used to manage program update of a vehicle device; and connecting the mobile device to the vehicle device, whereupon the proprietary micro-management application program makes a record of the program version of the vehicle device, and the mobile device transmits back the program version information of the vehicle device to a network server.

b, Performing a comparison of the program version of the vehicle device with the version on the network server. If the program version of the vehicle device is an older version, then the network server pushes an update note to the mobile device paired with the vehicle device and the vehicle device.

c, Displaying the update note on the screen of the mobile device display, and opening the proprietary micro-management application program of the mobile device; pressing the Yes key to agree to run the program, and downloading and storing the update file in the mobile device.

d, Connecting the mobile device to the vehicle device, whereupon the network server notifies the vehicle device to run the update program. The vehicle device displays information on the updated version and advises opening the proprietary micro-management application program window on the mobile device.

e, Pressing the Yes key to agree to run the update program, whereupon the mobile device transmits the update file to the vehicle device, and the vehicle device retrieves the update program from the update file and updates the vehicle device.

The aforementioned application program download and update method for vehicle device further comprises the following step:

f, Transmitting back an update completion note by the vehicle device after updating thereof, whereupon the mobile device then transmits the update completion note to the network server, and the network server makes a record of the updated version of the vehicle device.

The aforementioned vehicle device is paired with a plurality of mobile devices.

Regarding the aforementioned application program download and update method for vehicle device, step c further comprises displaying the update information on the screen of the vehicle device; pressing the Yes key to agree to run the program; and downloading and storing the update file in the vehicle device.

Advancements in the effectiveness of the present invention help avoid the waste of time and money in having to return the vehicle to the service depot for software update of past vehicle devices, as well as the trouble of having to train service depot personnel, ensuring they pay attention to details related to program updating, and so on, and allows the vehicle owner to download the update program to the vehicle device himself, thereby eliminating the formality and inconvenience of having to return the vehicle for servicing.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view of the system architecture of a first, second, and third embodiment of the present invention.

FIG. 2 is a schematic view (1) of an update note on a mobile device in an embodiment of the present invention.

FIG. 3 is a schematic view of an update window on a vehicle device of an embodiment of the present invention.

FIG. 4 is a schematic flow chart of the method and steps in the first embodiment of the present invention.

FIG. 5 is a schematic flow chart of the method and steps in the second embodiment of the present invention.

FIG. 6 is a schematic flow chart of the method and steps in the third embodiment of the present invention.

FIG. 7 is a schematic view (2) of an update note on a mobile device in an embodiment of the present invention.

### DETAILED DESCRIPTION OF THE PREFERRED EMBODIMENTS

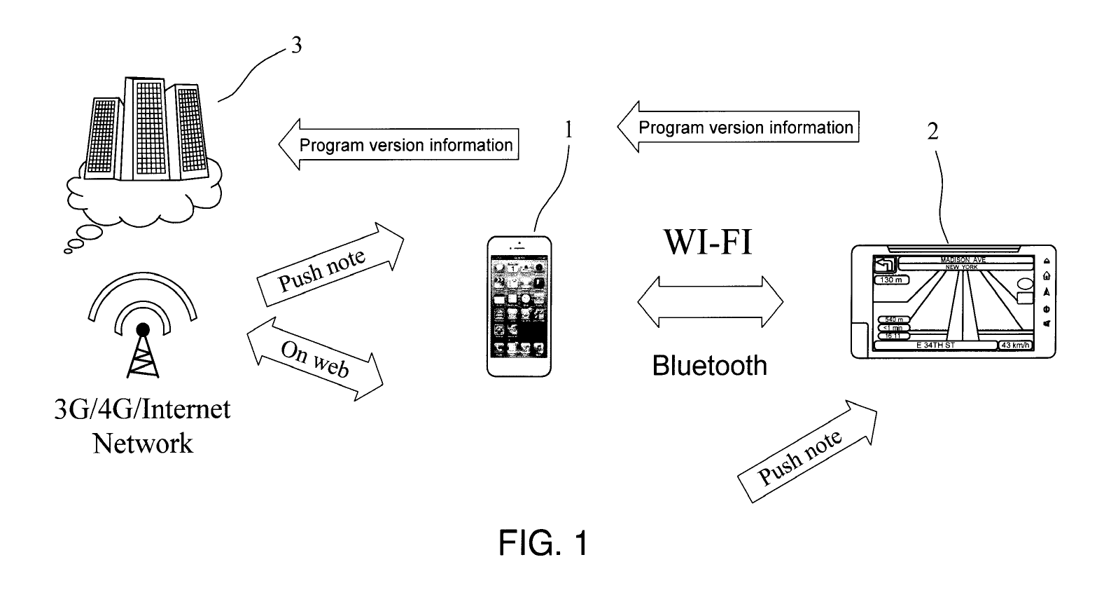

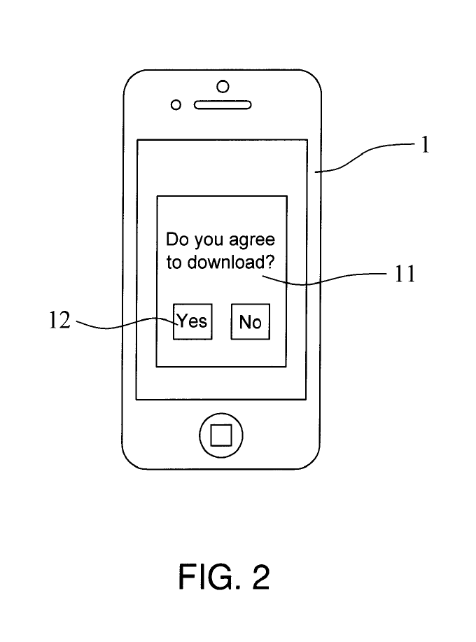

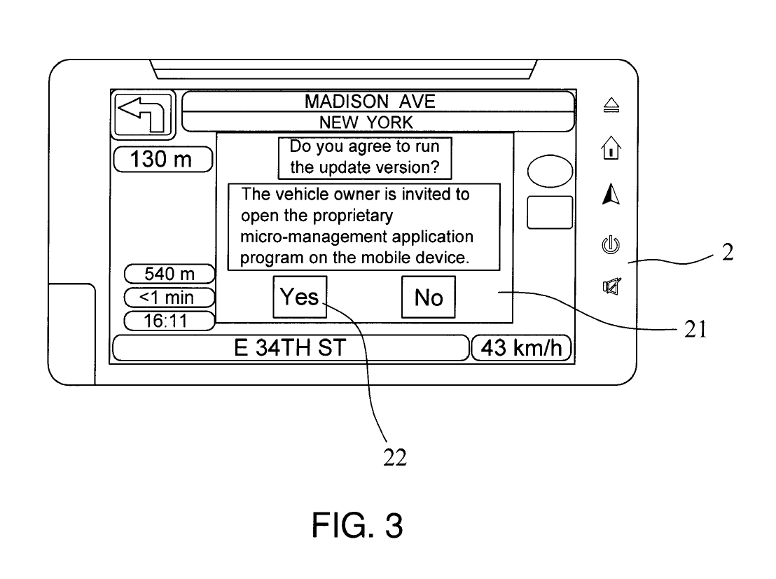

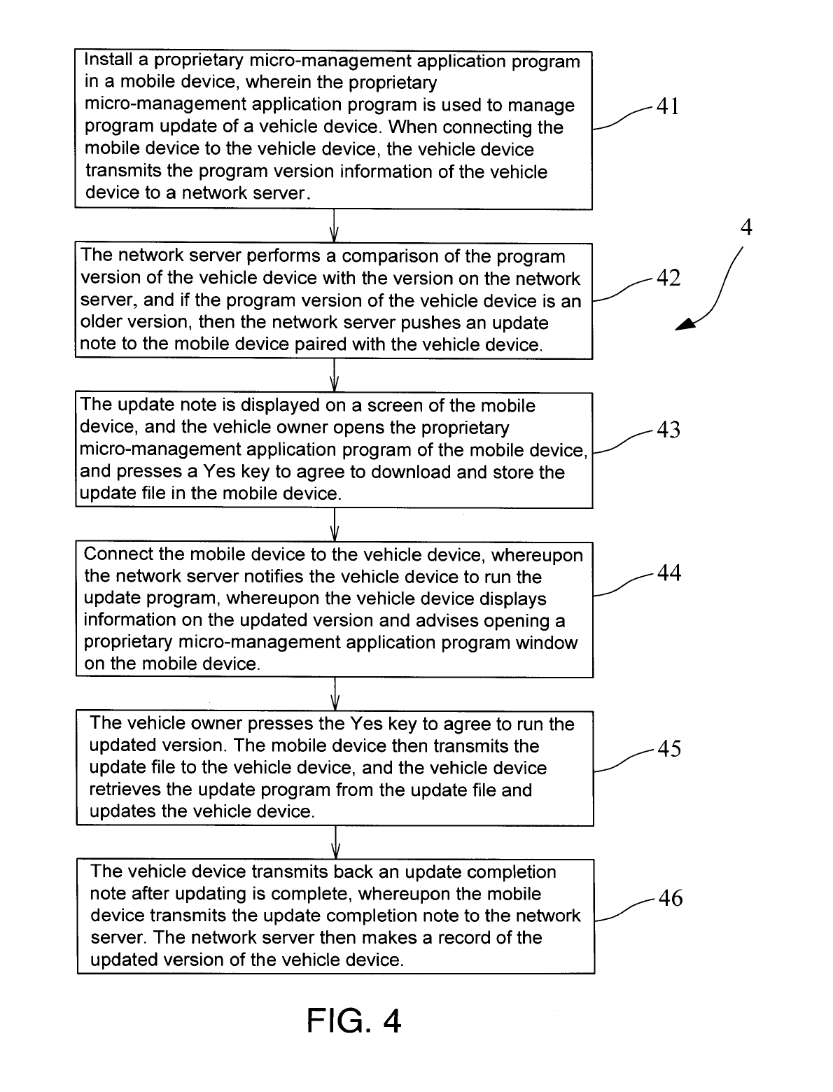

Referring to FIGS. 1, 2, 3, and 4, wherein a first embodiment of an application program download and update method 4 for vehicle device of the present invention comprises the following steps:

a, Installing a proprietary micro-management application program in a mobile device 1, wherein the proprietary micro-management application program is used to manage program update of a vehicle device 2; and connecting the mobile device 1 to the vehicle device 2, whereupon the vehicle device 2 transmits back the program version information of the vehicle device 2 to a network server 3 (step 41).

[In step 41, the vehicle owner installs the proprietary micro-management application program in the mobile device 1, wherein the proprietary micro-management application program is used to manage program update of the vehicle device 2. The mobile device 1 is a smart phone, or a tablet computer, and the vehicle device 2 is a vehicle mount computer, a vehicle Head Up Display, a ceiling-mounted multimedia player device, a headrest multimedia player device, or a hands free phone device. When connecting the mobile device 1 to the vehicle device 2, the mobile device 1 is Bluetooth paired with the vehicle device 2, and the vehicle device 2 Bluetooth links to a personal local-area network and connects to a network server 3. The vehicle device 2 then transmits the program version information of the vehicle device 2 to the network server 3.]

b, Performing a comparison of the program version of the vehicle device 2 with the version on the network server 3. If the program version of the vehicle device 2 is an older version, then the network server 3 pushes an update note to the mobile device 1 paired with the vehicle device 2 (step 42).

[In step 42, a vehicle depot or vehicle manufacturer establishes an update file from the update program for the vehicle device 2. The network server 3 performs a comparison of the vehicle device 2 with the version on the network server 3, and if the program version of the vehicle device 2 is an older version, then the network server 3 pushes an update note to the mobile device 1 paired with the vehicle device 2. The vehicle device 2 can be paired with a plurality of mobile devices.]

c, Displaying the update note on a screen 11 of the mobile device 1, and opening the proprietary micro-management application program of the mobile device 1; pressing a Yes key 12 to agree to run the program, and downloading and storing the update file in the mobile device 1 (step 43).

[In step 43, the update note is displayed on the screen 11 of the mobile device 1, and after seeing the update note, the vehicle owner can choose one of the mobile devices 1 paired with the vehicle device 2 to open the proprietary micro-management application program of the mobile device 1, and press the Yes key 12 to agree to download and store the update file in the mobile device 1. The network server 3 then makes a record of the mobile device 1 with the downloaded and updated file. The mobile device 1 transmits data by connecting with the network server 3 through 3G (3rd Generation), 4G (4th Generation), or the Internet.]

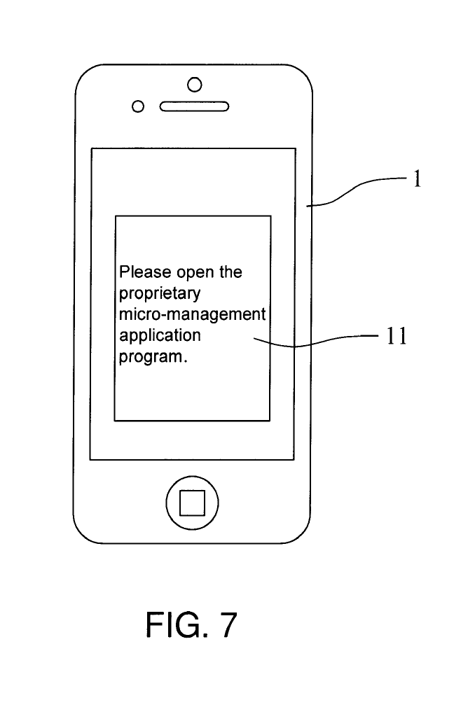

d, Connecting the mobile device 1 to the vehicle device 2, whereupon the network server 3 notifies the vehicle device 2 to run the program update. The vehicle device 2 then displays information on the updated version and advises opening a proprietary micro-management application program window 21 on the mobile device 1 (step 44).

[In step 44, the vehicle owner carries the mobile device 1 to the vehicle, and after connecting the mobile device 1 to the vehicle device 2, the network server 3 performs a comparison to determine whether or not the mobile device 1 has downloaded the update file. If there is an update file, then the network server 3 notifies the vehicle device 2 to run the update program, whereupon the vehicle device 2 displays the updated version and invites the vehicle owner to open the proprietary micro-management application program window 21 on the mobile device 1. The mobile device 1 then displays the updated version and invites the vehicle owner to open the proprietary micro-management application program window 21 on the mobile device 1 (as depicted in FIG. 7).]

e, Pressing the Yes key 22 to agree to run the updated version, whereupon the mobile device 1 transmits the update file to the vehicle device 2, and the vehicle device 2 retrieves the update program from the update file and updates the vehicle device 2 (step 45);

[In step 45, after opening the proprietary micro-management application program on the mobile device 1, the vehicle owner presses the Yes key 22 to agree to run the updated version. The mobile device 1 then transmits the update file to the vehicle device 2, and the vehicle device 2 retrieves the update program from the update file and updates the vehicle device 2. The mobile device 1 transmits data to the vehicle device 2 through a WI-FI (wireless fidelity) or Bluetooth connection.]

The aforementioned application program download and update method for vehicle device 4 further comprises the following step:

f, Transmitting back an update completion note by the vehicle device 2 after updating thereof, whereupon the mobile device 1 transmits the update completion note to the network server 3. The network server 3 then makes a record of the updated version of the vehicle device 2 (step 46).

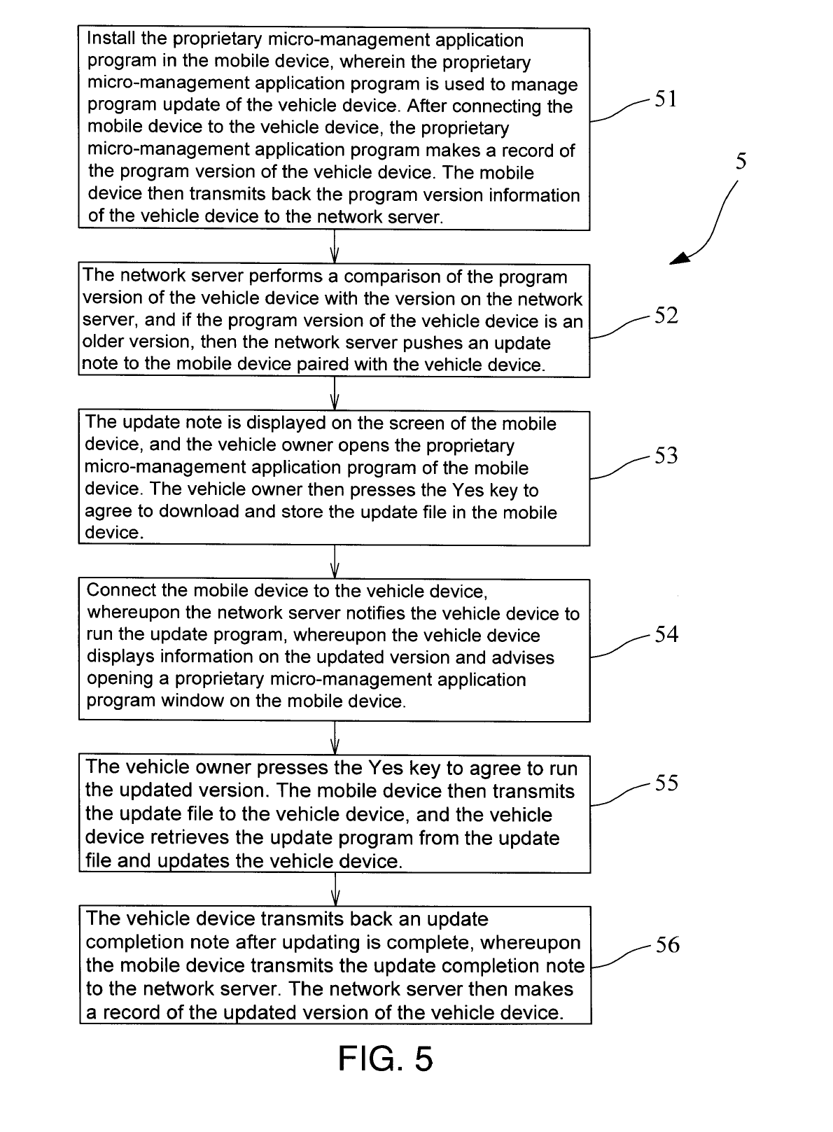

Referring to FIGS. 1, 2, 3 and 5, a second embodiment of the application program download and update method 5 for vehicle device of the present invention comprises the following steps:

a, Installing a proprietary micro-management application program in the mobile device 1, wherein the proprietary micro-management application program is used to manage program update of the vehicle device 2; and connecting the mobile device 1 to the vehicle device 2, whereupon the proprietary micro-management application program makes a record of the program version of the vehicle device 2. The mobile device 1 then transmits back the program version information of the vehicle device 2 to the network server 3 (step 51).

[In step 51, the vehicle owner installs the proprietary micro-management application program in the mobile device 1, wherein the proprietary micro-management application program is used to manage program update of the vehicle device 2. The mobile device 1 is a smart phone or a tablet computer. The vehicle owner carries the mobile device 1 to the vehicle, and after connecting the mobile device 1 to the vehicle device 2, the proprietary micro-management application program makes a record of the program version of the vehicle device 2. The vehicle device 2 transmits data to the mobile device 1 through a WI-FI or Bluetooth connection. The mobile device 1 then transmits back the program version information of the vehicle device 2 to the network server 3. The mobile device 1 transmits data to the network server 3 through a 3G or 4G connection, or through an Internet connection. The vehicle device 2 is a vehicle mount computer, a vehicle Head Up Display, a ceiling-mounted multimedia player device, a headrest multimedia player device, or a hands free phone device.]

b, Performing a comparison of the program version of the vehicle device 2 with the version on the network server 3. If the program version of the vehicle device 2 is an older version, then the network server 3 pushes an update note to the mobile device 1 paired with the vehicle device 2 (step 52).

[In step 52, a vehicle depot or vehicle manufacturer establishes an update file from the update program for the vehicle device 2. The network server 3 performs a comparison of the vehicle device 2 with the version on the network server 3, and if the program version of the vehicle device 2 is an older version, then the network server 3 pushes an update note to the mobile device 1 paired with the vehicle device 2. The vehicle device 2 can be paired with a plurality of the mobile devices 1.]

c, Displaying the update note on the screen 11 of the mobile device 1, and opening the proprietary micro-management application program of the mobile device 1; pressing the Yes key 12 to agree to run the program, and downloading and storing the update file in the mobile device 1 (step 53).

[In step 53, the update note is displayed on the screen 11 of the mobile device 1. After seeing the update note, the vehicle owner can choose one of the mobile devices 1 paired with the vehicle device 2, and open the proprietary micro-management application program of the mobile device 1. The vehicle owner then presses the Yes key 12 to agree to download and store the update file in the mobile device 1, whereupon the network server 3 makes a record of the mobile device 1 with the downloaded and updated file. The mobile device 1 transmits data to the network server 3 through a 3G or 4G connection, or through an Internet connection.]

d, Connecting the mobile device 1 to the vehicle device 2, whereupon the network server 3 notifies the vehicle device 2 to run the update program. The vehicle device 2 then displays information on the updated version and advises opening the proprietary micro-management application program window 21 on the mobile device 1 (step 54);

[In step 54, the vehicle owner carries the mobile device 1 to the vehicle, and after connecting the mobile device 1 to the vehicle device 2, the network server 3 performs a comparison to determine whether or not the mobile device 1 has downloaded the update file. If there is an update file, then the network server 3 notifies the vehicle device 2 to run the update program. The vehicle device 2 then displays the updated version and invites the vehicle owner to open the proprietary micro-management application program window 21 on the mobile device 1. The mobile device 2 then displays the updated version and invites the vehicle owner to open the proprietary micro-management application program window on the mobile device 1 (as depicted in FIG. 7).]

e, Pressing the Yes key 22 to agree to run the updated version, whereupon the mobile device 1 transmits the update file to the vehicle device 2, and the vehicle device 2 retrieves the update program from the update file and updates the vehicle device 2 (step 55);

[In step 55, after opening the proprietary micro-management application program on the mobile device 1, the vehicle owner presses the Yes key 22 to agree to run the updated version. The mobile device 1 then transmits the update file to the vehicle device 2, and the vehicle device 2 retrieves the update program from the update file and updates the vehicle device 2. The vehicle device 2 transmits data to the mobile device 1 through a WI-FI or Bluetooth connection.]

The aforementioned application program download and update method 5 for vehicle device further comprises the following step:

f, Transmitting back an update completion note by the vehicle device 2 after updating thereof, whereupon the mobile device 1 transmits the update completion note to the network server 3. The network server 3 then makes a record of the updated version of the vehicle device 2 (step 56).

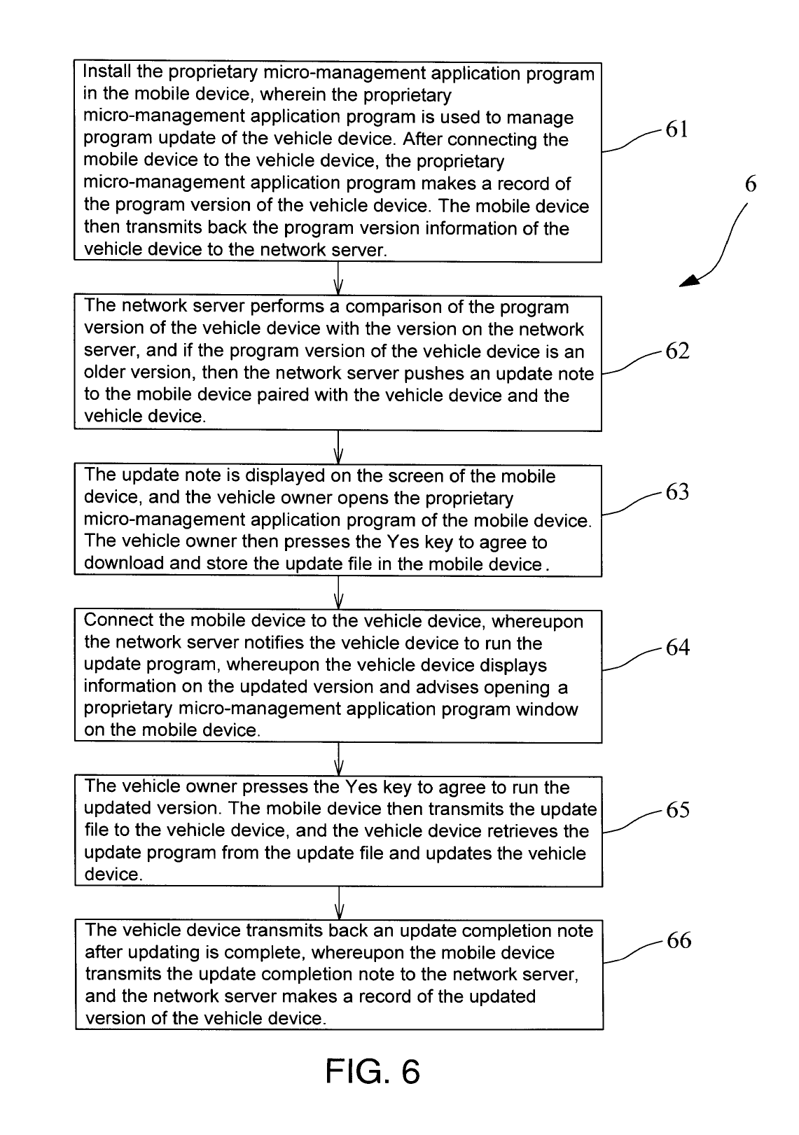

Referring to FIGS. 1, 2, 3 and 6, a third embodiment of an application program download and update method 6 for vehicle device of the present invention comprises the following steps:

a, Installing a proprietary micro-management application program in the mobile device 1, wherein the proprietary micro-management application program is used to manage program update of the vehicle device 2; and connecting the mobile device 1 to the vehicle device 2, whereupon the proprietary micro-management application program makes a record of the program version of the vehicle device 2. The mobile device 1 then transmits back the program version information of the vehicle device 2 to the network server 3 (step 61);

[In step 61, the vehicle owner installs the proprietary micro-management application program in the mobile device 1, wherein the proprietary micro-management application program is used to manage program update of the vehicle device 2. The mobile device 1 is a smart phone or a tablet computer. The vehicle owner carries the mobile device 1 to the vehicle, and after connecting the mobile device 1 to the vehicle device 2, the proprietary micro-management application program makes a record of the program version of the vehicle device 2. The vehicle device 2 transmits data to the mobile device 1 through a WI-FI or Bluetooth connection. The mobile device 1 then transmits back the program version information of the vehicle device 2 to the network server 3. The mobile device 1 transmits data to the network server 3 through a 3G or 4G connection, or through an Internet connection. The vehicle device 2 is a vehicle mount computer, a vehicle Head Up Display, a ceiling-mounted multimedia player device, a headrest multimedia player device, or a hands free phone device. The vehicle device 2 can also transmit back the program version information of the vehicle device 2 to the network server 1.]

b, Performing a comparison of the program version of the vehicle device 2 with the version on the network server 3. If the program version of the vehicle device 2 is an older version, then the network server 3 pushes an update note to the mobile device 1 paired with the vehicle device 2 and the vehicle device 2 (step 62);

[In step 62, when there is an update program for the vehicle device 2, a vehicle depot or vehicle manufacturer establishes an update file from the update program. The network server 3 performs a comparison of the program version of the vehicle device 2 with the version on the network server 3, and if the program version of the vehicle device 2 is an older version, then the network server 3 pushes an update note to the mobile device 1 paired with the vehicle device 2 and the vehicle device 2. The vehicle device 2 can be paired with a plurality of mobile devices.]

c, Displaying the update note on the screen 11 of the mobile device 1, opening the proprietary micro-management application program of the mobile device 1, and pressing the Yes key 12 to agree to download and store the update file in the mobile device 1 (step 63); [In step 63, the update note is displayed on the screen 11 of the mobile device 1. After seeing the update note, the vehicle owner can choose one of the mobile devices 1 paired with the vehicle device 2 to open the proprietary micro-management application program of the mobile device 1. The vehicle owner then presses the Yes key 12 to agree to download and store the update file in the mobile device 1, whereupon the network server 3 makes a record of the mobile device 1 with the downloaded and updated file. The mobile device 1 transmits data to the network server 3 through a 3G or 4G connection, or through an Internet connection.]

d, Connecting the mobile device 1 to the vehicle device 2, whereupon the network server 3 notifies the vehicle device 2 to run the update program. The vehicle device 2 then displays information on the updated version and advises opening the proprietary micro-management application program window 21 on the mobile device 1 (step 64);

[In step 64, the vehicle owner carries the mobile device 1 to the vehicle, and after connecting the mobile device 1 to the vehicle device 2, the network server 3 performs a comparison to determine whether or not the mobile device 1 has downloaded the update file. If there is an update file, then the network server 3 notifies the vehicle device 2 to run the update program. The vehicle device 2 displays the updated version and invites the vehicle owner to open the proprietary micro-management application program window 21 on the mobile device 1. The mobile device 1 then displays the updated version and invites the vehicle owner to open the proprietary micro-management application program window on the mobile device 1 (as depicted in FIG. 7).]

e, Pressing a Yes key 22 to agree to run the updated version, whereupon the mobile device 1 transmits the update file to the vehicle device 2, and the vehicle device 2 retrieves the update program from the update file and updates the vehicle device 2 (step 65);

[In step 65, after opening the proprietary micro-management application program on the mobile device 2, the vehicle owner presses the Yes key 22 to agree to run the updated version. The mobile device 1 then transmits the update file to the vehicle device 2, and the vehicle device 2 retrieves the update program from the update file and updates the vehicle device 2.

The aforementioned application program download and update method 6 for vehicle device further comprises the following step:

f, Transmitting back an update completion note by the vehicle device 2 after updating thereof, whereupon the mobile device 1 transmits the update completion note to the network server 3, and the network server 3 makes a record of the updated version of the vehicle device 2.

The aforementioned step c further comprises displaying the update note on the screen of the vehicle device 2, and pressing the Yes key to agree to download and store the update file in the vehicle device 2.

The methods and steps provided by the first, second, and third embodiments of the present invention effectively avoid the waste of time and money of previous methods because of the need to return the vehicle to the service depot to update software on the vehicle device 2, as well as the trouble of having to train service depot personnel, ensure they pay attention to details related to program updating, and so on, and allows the vehicle owner to download the update program to the vehicle device himself, thereby eliminating the formality and inconvenience of having to return the vehicle for servicing.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An application program download and update method for vehicle device, comprising the following steps:
a, installing a proprietary micro-management application program in a mobile device, wherein the proprietary micro-management application program is used to manage program update of a vehicle device; and connecting the mobile device to the vehicle device, whereupon the vehicle device transmits back the program version information of the vehicle device to a network server;
b, performing a comparison of the program version of the vehicle device by the network server; if the program version of the vehicle device is an older version, then the network server pushes an update note to the mobile device paired with the vehicle device;
c, displaying the update note on the screen of the mobile device, opening the proprietary micro-management application program of the mobile device, pressing a Yes key to agree to run the program, and downloading and storing an update file in the mobile device;
d, connecting the mobile device to the vehicle device, whereupon the network server notifies the vehicle device to run the update program, the vehicle device then displays information on the updated version and advises opening a proprietary micro-management application program window on the mobile device; and
e, pressing the Yes key to agree to run the updated version, whereupon the mobile device transmits the update file to the vehicle device, and the vehicle device retrieves the update program from the update file and updates the vehicle device.

2. The aforementioned application program download and update method for vehicle device as described in claim 1, further comprising the following step:
f, transmitting back an update completion note by the vehicle device after updating thereof, whereupon the mobile device transmits the update completion note to the network server, and the network server makes a record of the updated version of the vehicle device.

3. The aforementioned application program download and update method for vehicle device as described in claim 1, wherein the vehicle device is paired with a plurality of mobile devices.

4. An application program download and update method for vehicle device, comprising the following steps:
a, installing a proprietary micro-management application program in a mobile device, wherein the proprietary micro-management application program is used to manage program update of a vehicle device, when connecting the mobile device to the vehicle device, the proprietary micro-management application program makes a record of the program version of the vehicle device, and the mobile device transmits back the program version information of the vehicle device to a network server;
b, performing a comparison of the program version of the vehicle device by the network server, if the program version of the vehicle device is an older version, then the network server pushes an update note to the mobile device paired with the vehicle device;
c, displaying update information on a screen of the mobile device, opening the proprietary micro-management application program of the mobile device, pressing a Yes key to agree to run the program, and downloading and storing an update file in the mobile device;
d, connecting the mobile device to the vehicle device, whereupon the network server notifies the vehicle device to run the update program, the vehicle device then displays information on the updated version and advises opening the proprietary micro-management application program window on the mobile device; and
e, pressing the Yes key to agree to run the updated version, whereupon the mobile device transmits the update file to the vehicle device, the vehicle device retrieves the update program from the update file and updates the vehicle device.

5. The application program download and update method for vehicle device as described in claim 4, further comprising the following step:
f, transmitting back an update completion note by the vehicle device after updating thereof, whereupon the mobile device transmits the update completion note to the network server, and the network server makes a record of the updated version of the vehicle device.

6. The application program download and update method for vehicle device as described in claim 4, wherein the vehicle device is paired with a plurality of mobile devices.

7. An application program download and update method for vehicle device, comprising:
a, installing a proprietary micro-management application program in a mobile device, wherein the proprietary micro-management application program is used to manage program update of a vehicle device, when connecting the mobile device to the vehicle device, the proprietary micro-management application program makes a record of the program version of the vehicle device, and the mobile device transmits back the program version information of the vehicle device to the network server;
b, performing a comparison of the program version of the vehicle device by the network server, If the program version of the vehicle device is an older version, then the network server pushes an update note to the mobile device paired with the vehicle device and the vehicle device;
c, displaying update information on a screen of the mobile device, opening the proprietary micro-management application program of the mobile device, pressing a Yes key to agree to run the program, and downloading and storing an update file in the mobile device;
d, connecting the mobile device to the vehicle device, whereupon the network server notifies the vehicle device to run the update program, the vehicle device then displays information on the updated version and advises opening the proprietary micro-management application program window on the mobile device; and
e, pressing the Yes key to agree to run the updated version, whereupon the mobile device transmits the update file to the vehicle device, and the vehicle device retrieves the update program from the update file and updates the vehicle device.

8. The application program download and update method for vehicle device as described in claim 7, further comprising the following step:
f, transmitting back an update completion note by the vehicle device after updating thereof, whereupon the mobile device transmits the update completion note to the network server, and the network server makes a record of the updated version of the vehicle device.

9. The application program download and update method for vehicle device as described in claim 7, wherein the vehicle device is paired with a plurality of mobile devices.

10. The application program download and update method for vehicle device as described in claim 7, wherein step c further comprises displaying update information on the screen of the vehicle device, pressing a Yes key to agree to run the program, and downloading and storing an update file in the mobile device.
